(19) United States
(12) Patent Application Publication
(10) Pub. No.: US 2012/0278605 A1
(43) Pub. Date: Nov. 1, 2012

(54) PORTABLE STORAGE DEVICE COMMUNICATING VIA A USB 3.0 PROTOCOL AND A COMPUTER SYSTEM HAVING THE SAME

(75) Inventors: Young Goan Kim, Seoul (KR); Yong Sik Joo, Seoul (KR)

(73) Assignee: NOVACHIPS CO., LTD., Seongnam-si, Gyeonggi-do (KR)

(21) Appl. No.: 13/517,286

(22) PCT Filed: Dec. 6, 2010
(86) PCT No.: PCT/KR2010/008673

§ 371 Date: Jun. 20, 2012

(30) Foreign Application Priority Data
Dec. 23, 2009 (KR) 10-2009-0129691

(51) Int. Cl. G06F 13/14; G06F 9/06

(52) U.S. Cl. 713/2; 710/33

(57) ABSTRACT

The present invention relates to a portable storage device communicating via a USB 3.0 protocol and a computer system having the same. The computer system according to one embodiment of the present invention comprises a portable storage device and a computer. The portable storage device includes an operating system (OS) storage region for storing OS data and boot data which are not sent to the computer through a transmission channel used for data transmission via the USB 3.0 protocol, requested by a receiving channel used for receiving data via the USB 3.0 protocol, and loaded on the computer to drive the computer.

### BACKGROUND OF THE INVENTION

1. Field of the Invention

The present invention relates to a portable storage device and a computer system including the portable storage device, and more particularly to a portable storage device communicating via an USB 3.0 protocol and a computer system including the portable storage device.

2. Description of the Prior Art

Due to breakthroughs in technologies of wireless communication and a portable storage device, users can use computers anytime and anywhere. However, there still exists a problem of being unable to use data of the storage device if an operating system of the computer is different.

### SUMMARY OF THE INVENTION

In accordance with an aspect of the present invention, there is provided a computer system including a portable storage device; and a computer, wherein the portable storage device comprises an OS (Operating System) storage area for storing OS data and boot data transmitted to the computer through a transmission channel transmitting data via a USB (Universal Serial Bus) 3.0 protocol, requested to be transmitted to the computer through a reception channel receiving data via the USB 3.0 protocol, and loaded on the computer to operate the computer.

The computer may be set such that the computer is booted by receiving the boot data from the portable storage device.

The portable storage device and the computer may communicate through a wired or a wireless channel.

The OS data may be stored and transmitted in a manner defined as User defined Class which is not defined on a USB standard. Alternatively, the OS data may be stored and transmitted in a manner defined as Mass Storage Class on the USB standard.

In accordance with another aspect of the present invention, there is provided a portable storage device including an OS storage area for storing OS data transmitted to an external computer through a transmission channel transmitting data via a USB (Universal Serial Bus) 3.0 protocol, requested to be transmitted to the computer through a reception channel receiving data via the USB 3.0 protocol, and loaded on the computer to operate the computer.

In accordance with another aspect of the present invention, there is provided a computer system including a plurality of terminals connected to a network; and a plurality of portable storage devices, each of the plurality of portable storage device being connected to a corresponding terminal among the plurality of terminals via a USB 3.0 protocol, wherein said each of the portable storage devices comprises an OS storage area for storing OS data and boot data transmitted to a corresponding terminal through a transmission channel transmitting data via a USB (Universal Serial Bus) 3.0 protocol, requested to be transmitted to the corresponding terminal through a reception channel receiving data via the USB 3.0 protocol, and loaded on the corresponding terminal to operate the corresponding terminal.

Each of the terminals may be a clouding computer.

### BRIEF DESCRIPTION OF THE DRAWINGS

A brief description of each drawing is provided to more sufficiently understand the drawings cited in the detailed description of the present invention.

FIG. 1 illustrates a computer system according to an embodiment of the present invention.

FIG. 2 illustrates an example of storing an OS in a portable storage device of FIG. 1.

FIG. 3 illustrates another example of storing an OS in the portable storage device of FIG. 1.

FIG. 4 illustrates an example of driving computers operated by different OSs by using the portable storage device of FIG. 1.

FIG. 5 illustrates a computer system according to another embodiment of the present invention.

### DETAILED DESCRIPTION OF THE EXEMPLARY EMBODIMENTS

The above and other aspects, features and advantages of the present invention will be more apparent from the following detailed description taken in conjunction with the accompanying drawings.

Hereinafter, exemplary embodiments of the present invention will be described with reference to accompanying drawings in detail so that those skilled in the art may easily implement the present invention.

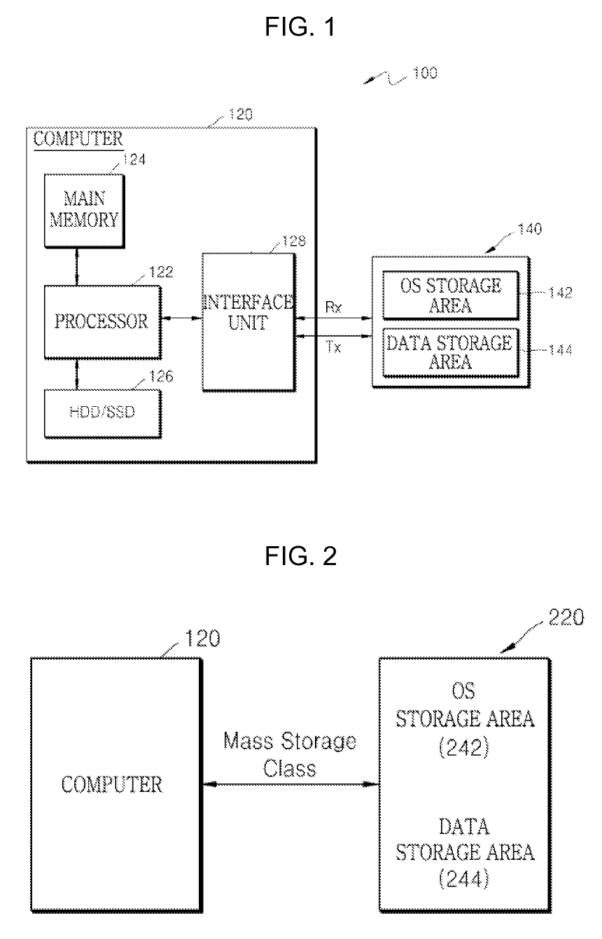

FIG. 1 illustrates a computer system according to an embodiment of the present invention.

Referring to FIG. 1, a computer system 100 according to embodiments of the present invention includes a computer 120 and a portable storage device 140.

The computer 120 includes a processor 122, a main memory 124, a sub disk drive 126, and an interface unit 128. The processor 122 and the sub disk drive 126 of the computer 120 transmit/receive data by using an SATA (Serial Advanced Technology Attachment) or a PATA (Parallel Advanced Technology Attachment) protocol. The SATA protocol supports data of 150˜300 MB/s. The sub disk drive 126 may be a HDD (Hard Disk Drive), an SSD (Solid State Drive) and the like.

The portable storage device 140 includes an OS storage area 142 and a data storage area 144. The OS storage area 142 stores boot data and OS (Operating System) data. However, hereinafter, only the OS data is described for convenience of the description.

The portable storage device 140 according to embodiments of the present invention is sold in a state where the OS is stored in the portable storage device 140 by a seller of the portable storage device or a user such as a manufacturer. Alternatively, a user (a purchaser of the portable storage device) except for the seller or the manufacturer can use the portable storage device after the user purchases the portable storage device in which no OS is stored and then stores the OS in the portable storage device. The data storage area 144 stores generally normal data.

The interface unit 128 of the computer 120 according to embodiments of the present invention can be booted using the OS stored in the portable storage device 140. The seller, the manufacturer, or the user can set a CMOS of the computer 120 such that the computer 120 is booted with the portable storage device 140.

The interface unit 128 of the computer 120 and the portable storage device 140 can communicate with each other via an USB 3.0 interface. That is, OS data stored in the OS storage area 142 of the portable storage device 140 according to embodiments of the present invention is transmitted to the computer 120 via the USB 3.0 interface. A bandwidth of the USB 3.0 interface corresponds to 400˜500 MB/s. This rate is faster than a data transmission rate of the SATA interface between the processor 122 of the computer 120 and the sub disk drive 126. Further, the portable storage device 140 communicating with the computer 120 via the USB 3.0 interface according to embodiments of the present invention can communicate with the computer 120 at a faster speed in comparison with the SSD.

Accordingly, according to the portable storage device 140 and the computer system 100 according to the present invention, it is possible to operate the computer with an OS desired by the user regardless of an

OS of the computer by operating the computer with an OS stored in the portable storage device at a fast transmission speed of the USB 3.0. Further, according to the portable storage device 140 and the computer system 100 according to the present invention, although a user uses an external computer, the user can use the computer in an environment of an OS, data, and a desktop of the user by operating the computer with an OS stored in the portable storage device which the user can easily carry.

However, in a conventional art, it is difficult to transmit/receive OS data to/from the computer since a maximum speed of a conventional portable storage device cannot exceed about 30 MB/s when data stored in the portable storage device is extracted.

Continuously referring to FIG. 1, the portable storage device 140 and the computer 120 according to embodiments of the present invention can communicate with each other by using a transmission channel (Tx) and a reception channel (Rx), respectively. That is, OS data is transmitted to the computer through the transmission channel (Tx), or transmission of the OS data from the computer is requested through the reception channel (Rx). Further, the portable storage device 140 and the computer 120 according to embodiments of the present invention can wirelessly communicate with each other. Furthermore, the sub disk drive 126 can store the OS. In this case, the computer 120 can be operated with an OS of the portable storage device 140 or operated with an OS of the sub disk drive 126 according to a setting of the CMOS.

FIG. 2 illustrates an example of storing an OS in a portable storage device of FIG. 1.

Referring to FIG. 2, an OS stored in an OS storage area 242 of a portable storage device 240 of FIG. 2 is stored using Mass Storage Class defined in a USB (Universal Serial Bus) standard, and can be loaded on the main memory 124 of the computer 120. That is, in transmitting/receiving OS data to/from the computer 120, the portable storage device 240 according to embodiments of the present invention can transmit OS data with standards such as a header, a segment, and an error recovery defined by Mass Storage Class like transmission/reception for normal data.

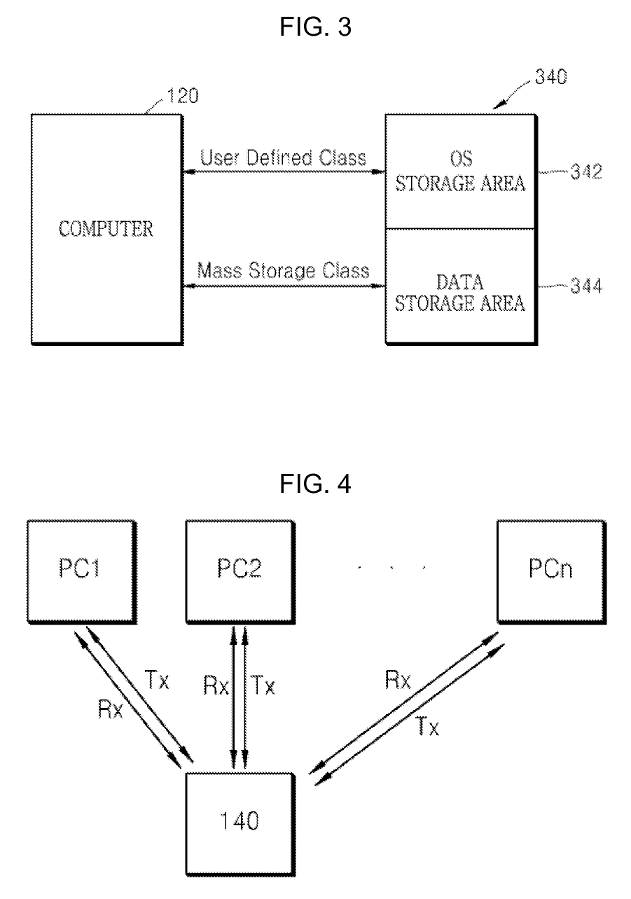

FIG. 3 illustrates another example of storing an OS in the portable storage device of FIG. 1.

Referring to FIG. 3, an OS stored in an OS storage area 342 of a portable storage device 340 according to embodiments of the present invention is stored using User defined Class which is not defined in the USB standard, and can be loaded on the computer 120. That is, in transmitting OS data to the computer 120, the portable storage device 340 according to embodiments of the present invention can transmit the OS data with standards such as a header, a segment, and an error recovery defined by the user. Normal data of FIG. 3 can be transmitted/received through Mass Storage Class defined in the USB standard.

FIG. 3 illustrates that the portable storage device 340 and the computer 120 have separate channels for OS data and normal data, but it is only for showing that the OS data of the portable storage device 340 is transmitted through User defined Class, and the normal data is transmitted/received through Mass Storage Class. Even if classes are different, channels of the portable storage device 340 and the computer 120 are not different.

As shown in FIG. 3, by storing and transmitting the OS (OS data) by using User defined Class, the OS storage area 342 of the portable storage device 340 of FIG. 3 cannot be accessed using a Mass Storage Class protocol. Accordingly, it is possible to keep the security of the OS stored in the portable storage device 34. Further, it is possible to provide something the user wants by storing and transmitting the OS (OS data) by using User defined Class. For example, in transmitting the OS data, User defined Class can be designed with the reflection of a demand of the user for a header, a segment, an error recovery, etc.

FIG. 4 illustrates an example of driving computers operated by different OSs by using the portable storage device of FIG. 1.

Referring to FIG. 4, the portable storage device 140 of FIG. 1 can operate computers PC1, PC2, . . . , PCn, which are driven with different OSs, with an OS stored in the portable storage device 140. That is, the computers can be operated with the OS which the user desires to use regardless of OSs of the computers PC1, PC2, . . . , PCn.

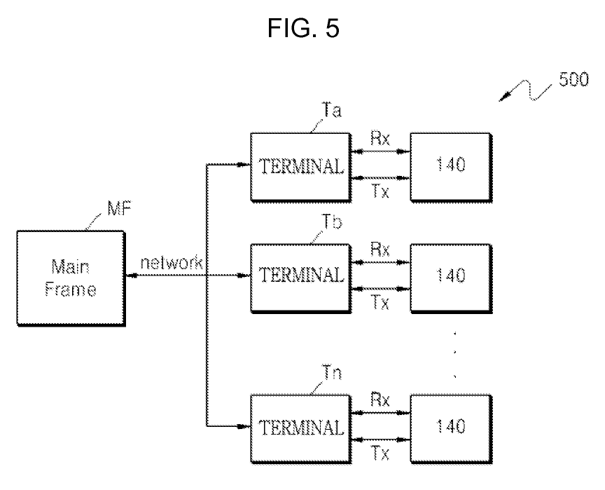

FIG. 5 illustrates a computer system according to another embodiment of the present invention.

Referring to FIG. 5, in a computer system 500 of FIG. 5, a Main Frame MF (server) is connected to terminals Ta, Tb, . . . , Tn through a network. The main frame MF can have the same construction as that of the computer 120 of FIG. 1.

Each of the terminals Ta, Tb, . . . , Tn receives OS data from the portable storage device 140 or transmits a request for the OS data to the portable storage device 140 via the USB 3.0 interface. Each of the terminals Ta, Tb, . . . , Tn can be the computer of FIG. 1. Further, Each of the terminals Ta, Tb, . . . , Tn of FIG. 5 can be a clouding computer equipped with only a monitor and a terminal.

The portable storage devices 140 included in the computer system 500 of FIG. 5 can store and transmit the OS (OS data) in the same way as that of FIG. 2 or FIG. 3.

According to the portable storage device and the computer system including the portable storage device according to embodiments of the present invention, any random terminal can perform a computing operation according to its environment, so that the portable storage device and the computer system may be suitable for a clouding system including the clouding computer.

According to the portable storage device and the computer system including the portable storage device according to the present invention, there is an advantage in that the computer can be operated with an OS which the user desires to use regardless of an OS of the computer by operating the computer with an OS stored in the portable storage device by using a fast transmission speed of the USB 3.0 interface. Accordingly, the portable storage device and the computer system including the portable storage device according to the present invention can optimize a clouding system including a clouding computer operated through allocation of resources from a server, which includes only a monitor and a simple terminal, connected with the computer through a network.

Also, according to the portable storage device and the computer system including the portable storage device according to the present invention, the security of the OS can be improved by storing OS data in a user defined area of the portable storage device.

As described above, optimized embodiments for the drawings and the specification are disclosed. Although particular terms are used herein, the terms are used only with the purpose of describing the present invention and do not limit the scope of the present invention.

While the detailed description of the present invention has described certain exemplary embodiments such as a portable terminal, it will be understood by those skilled in the art that various changes in form and details may be made therein without departing from the spirit and scope of the invention as defined by the appended claims.

What is claimed is:

1. A computer system comprising:
a portable storage device; and
a computer,
wherein the portable storage device comprises an OS (Operating System) storage area for storing OS data and boot data transmitted to the computer through a transmission channel transmitting data via a USB (Universal Serial Bus) 3.0 protocol, requested to be transmitted to the computer through a reception channel receiving data via the USB 3.0 protocol, and loaded on the computer to operate the computer,
wherein the OS data is stored and transmitted in a manner defined as User defined Class which is not defined on a USB standard.

2. The computer system as claimed in claim 1, wherein the computer is set such that the computer is booted by receiving the boot data from the portable storage device.

3. The computer system as claimed in claim 1, wherein the portable storage device and the computer communicate through a wired or a wireless channel.

4. The computer system as claimed in claim 1, wherein the OS data is stored and transmitted in a manner defined as Mass Storage Class on the USB standard.

5. A portable storage device comprising:
an OS storage area for storing OS data transmitted to an external computer through a transmission channel transmitting data via a USB (Universal Serial Bus) 3.0 protocol, requested to be transmitted to the computer through a reception channel receiving data via the USB 3.0 protocol, and loaded on the computer to operate the computer;
wherein the OS data is stored and transmitted in a manner defined as User defined Class which is not defined on a USB standard.

6. The portable storage device as claimed in claim 5, wherein the OS data is stored and transmitted in a manner defined as Mass Storage Class on the USB standard.

7. A computer system comprising:
a plurality of terminals connected to a network; and
a plurality of portable storage devices, each of the plurality of portable storage device being connected to a corresponding terminal among the plurality of terminals via a USB 3.0 protocol,
wherein said each of the portable storage devices comprises an OS storage area for storing OS data and boot data transmitted to a corresponding terminal through a transmission channel transmitting data via a USB (Universal Serial Bus) 3.0 protocol, requested to be transmitted to the corresponding terminal through a reception channel receiving data via the USB 3.0 protocol, and loaded on the corresponding terminal to operate the corresponding terminal,
wherein the OS data is stored and transmitted in a manner defined as User defined Class which is not defined on a USB standard.

8. The computer system as claimed in claim 7, wherein the OS data is stored and transmitted in a manner defined as Mass Storage Class on the USB standard.

9. The computer system as claimed in claim 7, wherein said each of the terminals is a clouding computer.
